(19) United States
(12) Patent Application Publication
(10) Pub. No.: US 2025/0286388 A1
(43) Pub. Date: Sep. 11, 2025

(54) BATTERY MANAGEMENT SYSTEM FOR ENERGY CONTROL

(71) Applicant: Standard Energy Inc., Daejeon (KR)

(72) Inventors: Dong Young Lee, Seoul (KR); Gwang Chan Choi, Seoul (KR)

(21) Appl. No.: 18/859,982

(22) PCT Filed: Jun. 13, 2023
(86) PCT No.: PCT/KR2023/008093

§ 371 Date: Oct. 24, 2024

(30) Foreign Application Priority Data
Jun. 13, 2022 (KR) 10-2022-0071705

(51) Int. Cl. H02J 7/00; H01M 10/42; H01M 10/63; H01M 10/6551

(52) U.S. Cl. CPC H02J 7/0019; H01M 10/425; H01M 10/63; H01M 10/6551; H02J 7/0016; H02J 7/0048; H02J 7/007182; H02J 7/007194; H01M 2010/4271

(57) ABSTRACT

The present disclosure relates to a battery management system for energy control and, more specifically, to a battery management system for controlling energy by stably managing, using a new current management means, battery conditions that change due to internal or external factors during the charging and discharging process of a battery cell, so as to enable optimized charging and discharging of the battery cell.

### TECHNICAL FIELD

The present disclosure relates to a battery management system for energy control, and more particularly to a battery management system for controlling energy by stably managing the conditions of a battery changed by internal or external factors during a charging and discharging process of a battery cell to enable optimized charging and discharging of the battery cell through a novel current management means.

### BACKGROUND ART

Unless otherwise indicated in this specification, the contents described in this section are not the prior art to the claims of this application, and inclusion in this section does not constitute the prior art.

The rapid development of industry has led to a dramatic increase in energy consumption, resulting in environmental changes and global warming.

As the world economy continues to grow, the proportion of renewable energy based on solar power, wind power, etc. is increasing. Among various apparatuses for utilizing energy sources including renewable energy, an energy storage system (ESS) is actively being used.

The use of the ESS as a storage system for sustainable renewable energy often involves intermittent utilization of multiple forms of energy. In order to improve the stability of grid networks against fluctuations caused by the intermittent availability of renewable energy, the ESS may be used to store surplus electricity and transmit the stored electricity to end customers or power grids for use when needed.

Batteries constituting the ESS thus used may be secondary batteries that store and release electrochemical energy, which may provide cost-effective and clean energy storage solutions.

Examples of conventional ESS configurations for electrochemical energy storage include lithium-ion, lead-acid, sodium-sulfur, and redox-flow batteries. However, during the use of the ESS, different storage cycles are required for different applications such as short-term storage, medium-term storage, and long-term storage. These different types have different physical and/or chemical properties.

Therefore, some examples of factors that determine the suitability of these electrochemical ESSs for a specific application include investment costs, power, energy, lifespan, recyclability, efficiency, scalability, and maintenance costs. These competing factors are therefore considered when selecting and designing an appropriate electrochemical ESS.

Among these factors, the balancing of the battery cells constituting the ESS has recently been recognized as an important factor for efficient management of the ESS. It has been recognized that the stabilization state can be effectively achieved by balancing the battery cells and managing the state of charge (SoC) thereof, especially the temperature thereof.

However, it is not easy to stably manage the temperature in order to efficiently manage the functions of the batteries, and it is difficult to set appropriate conditions for efficiently managing the functions by adjusting balancing, etc. according to the characteristics and configuration of the battery cells constituting the ESS.

As a conventional energy control technology for the battery cells of the ESS, Korean Patent Registration No. 10-2004332 proposes a method of simultaneously performing active balancing and passive balancing by applying energy from a cell having a higher voltage to a cell having a lower voltage through passive balancing resistance until the cell voltage reaches a target voltage. However, this balancing method is limited in use because it is uneconomical to utilize balancing resistance for active balancing.

In addition, as another example, Korean Patent Registration No. 10-2373716 proposes a technology including a discharge resistor that consumes energy transferred from a cell as thermal energy and a discharge switch that controls the current flowing in the discharge resistor, as an example of a method of monitoring the voltage deviation between cells through a voltage measurement unit and connecting at least one of the cells to an active cell balancing unit and a passive balancing unit through a balancing switching unit to balance cell voltages through any one of the active cell balancing unit and the passive balancing unit according to the monitoring results. However, even in this case, there is a problem that an energy control means is complicated by simultaneously performing active balancing in addition to passive balancing for cell balancing, whereby the efficiency of energy control for passive balancing is not good.

### PRIOR ART DOCUMENTS

### Patent Documents

(Patent Document 1) Korean Patent Registration No. 10-2004332
(Patent Document 2) Korean Patent Registration No. 10-2373716

### DISCLOSURE

### Technical Task

The present disclosure aims to solve the above problems and to present a scheme to stably manage an ESS by controlling energy in an economical and simple way for balancing of battery cells constituting the ESS.

Therefore, it is an object of the present disclosure to provide a system for managing a battery based on cell balancing by controlling energy of battery cells.

It is another object of the present disclosure to a method of controlling balancing of battery cells in a rapid, reliable, economical, and efficient manner by properly managing heat, such as by using resistance in the battery.

It is a further object of the present disclosure to a battery management system for minimizing cell deviation due to internal resistance through energy control in an ESS including a plurality of battery cells and for using relatively high current to charge and discharge the batteries.

The objects of the present disclosure are not limited to the above objects, but are to be understood to include all objects that can be inferred from the detailed description of the present disclosure or the configuration of the present disclosure described in the claims or all objects that can be achieved by the description or technical idea of the present disclosure.

### Technical Solutions

In order to accomplish the above objects, the present disclosure provides a battery management system for energy control configured to balance the voltage of each cell in the state in which a plurality of battery cells is connected to each other, the battery management system including a voltage measurement device, a switch configured to be opened and closed according to the voltage; and a current management means configured to consume or utilize current bypassed when the switch is closed, whereby temperature management is achieved.

According to a preferred embodiment of the present disclosure, the bypass current may be increased to maintain temperature stability while performing rapid cell balancing.

According to a preferred embodiment of the present disclosure, the battery management system may include a resistance facility for bypass configured to perform temperature management.

According to a preferred embodiment of the present disclosure, the resistance facility for bypass may include a resistance means having an allowable power value of at least 1 W.

According to a preferred embodiment of the present disclosure, the resistance facility for bypass may have a standard resistor area of 60 mm² or more when the standard resistor package number is 4000 or higher.

According to a preferred embodiment of the present disclosure, the resistance facility for bypass may include a resistor having a resistance of less than 1.5Ω to 1μΩ, a width of 0.09 to 0.34 mm, and a length of 140 to 210 mm when the standard resistor package number is 4000 or higher, in a configuration wherein the width and length of the resistor increase in a mutually proportional ratio in proportion to a decrease in the resistance and wherein the proportional relationship is established in a regular or irregular ratio within the range. According to a preferred embodiment of the present disclosure, the resistance facility for bypass may include a wire-type resistor having one or more of a snail structure, a spiral structure, a series or parallel type straight cluster structure, a curved cluster structure, or a mixed cluster structure.

According to a preferred embodiment of the present disclosure, the resistance facility for bypass may include a short circuit means configured to cause short circuit when the current is equal to or greater than a set threshold current.

According to a preferred embodiment of the present disclosure, the resistance facility for bypass may have a single-layer or multilayer arrangement on or under a printed circuit board (PCB) and may be configured such that currents in resistors flow in opposite directions at positions corresponding to each other.

According to a preferred embodiment of the present disclosure, the battery management system may include a heat dissipation means.

According to a preferred embodiment of the present disclosure, the battery management system may include a structure for sharing heat between the battery cells.

According to a preferred embodiment of the present disclosure, the heat dissipation means may include a heat sink attached to dissipate heat or a fin structure for heat dissipation.

According to a preferred embodiment of the present disclosure, the battery management system may include a means configured to dissipate heat by driving a motor using a balancing current.

According to a preferred embodiment of the present disclosure, dissipated thermal energy may be collected and utilized as an additional source of energy.

According to a preferred embodiment of the present disclosure, the battery management system may include a temperature sensor provided at or around each of the battery cells.

According to a preferred embodiment of the present disclosure, the temperature sensor may include a temperature sensitive material.

According to a preferred embodiment of the present disclosure, the temperature sensitive material may be provided in the form of paint or a sheet.

In addition, the present disclosure provides a battery management method including: measuring the voltage of battery cells connected to each other, the voltage of the battery cells being increased to perform voltage uniformity matching between the battery cells when measuring the voltage;
performing selective switching such that a bypass current selectively flows to one or more loads connected to each of the battery cells;
checking each of the one or more loads that consume or utilize the bypass current after each switch is actuated for a corresponding one of the loads; and
performing relatively rapid cell balancing of the battery cells to achieve stable thermal management compared to a conventional method that does not utilize the bypass current.

According to a preferred embodiment of the present disclosure, the relatively rapid cell balancing may be performed taking into account at least one of following conditions after performing at least one of the measurement step, the switching step, and the checking step:
the bypass current may have a relatively large size to increase a balancing current when the amount of imbalance to a corresponding battery cell is severe;
the relatively large current used for cell balancing may generate a relatively large amount of heat;
a correspondingly low load resistance may be required to increase the current for cell balancing; and
the one or more loads may have a relatively large size to achieve a relatively low resistance, in which case the cost may be increased and the size of a printed circuit board (PCB) of a BMS may be increased.

According to a preferred embodiment of the present disclosure, at least one of the loads may include one or more conductive lines having a specific layout integrated into the PCB instead of using a conventional resistor part.

According to a preferred embodiment of the present disclosure, heat dissipation for the conductive lines may be achieved by employing at least one of specific distances between the conductive lines, a heat sink, and a heat dissipating fin element.

According to a preferred embodiment of the present disclosure, at least one of the loads may be a motor load related to a motor provided at or near the PCB, whereby the motor may be operated to achieve temperature peak shaving in the BMS or to direct heat away from the PCB.

According to a preferred embodiment of the present disclosure, a temperature sensitive paint or a color-changing element may be applied or disposed at or near the PCB to visually determine whether heat dissipation is effective.

In addition, the present disclosure provides a battery management system for energy control configured to perform a method of balancing the voltage of each cell in the state in which a plurality of vanadium-based battery cells is connected to each other, the battery management system including a voltage measurement device; a switch configured to be turned on or off in accordance with the voltage, a resistance means applied to a PCB in a laminated state as a current management means configured to consume or utilize current bypassed in the state in which the switch is on, and a means configured to control energy using the resistance means to perform cell balancing and to manage temperature generated during an energy control process, whereby a battery charging and discharging state is stabilized.

According to a preferred embodiment of the present disclosure, performing the cell balancing may include actively or passively balancing the state of charge (SoC) value and performing temperature management of the vanadium-based battery cells by increasing the temperature of the vanadium-based batteries by 5° C. or more.

According to a preferred embodiment of the present disclosure, the temperature management may include maintaining an optimal operating efficiency temperature range of 15 to 40° C. and performing control such that the temperature does not exceed 50° C. in any case.

### Advantageous Effects

According to the present disclosure, heat or temperature may be managed through energy control to reliably manage the physical and chemical changes, such as the capacity and temperature of each cell, caused by internal or external factors during the charging and discharging process of the battery cells, to enable optimized charging and discharging of the battery cells.

Particularly, in the present disclosure, energy control is performed using a bypass current, and resistance is formed under certain conditions to stably manage the temperature, whereby it is possible to effectively improve balancing of the battery cells and battery efficiency.

The effects of the present disclosure are not limited to the above effects, but are to be understood to include all effects that can be inferred from the detailed description of the present disclosure or from the configuration of the present disclosure described in the claims.

### DESCRIPTION OF DRAWINGS

FIG. 1A schematically shows an exemplary state of charge of battery cells in an ESS in an unmanaged state of energy control.

FIG. 1B schematically shows an exemplary state of charge of battery cells in an ESS in a managed state of energy control.

FIG. 2A schematically shows an example of active balancing of battery cells in an ESS.

FIG. 2B schematically shows an example of passive balancing of battery cells in an ESS.

FIG. 3 schematically shows an exemplary battery management system electrically connected to a battery system constituting an ESS and including a plurality of battery cells designed such that energy control is possible by utilization of resistors.

FIG. 4A conceptually shows an example configuration of an exemplary form of resistor applicable on a PCB of a BMS in accordance with the present disclosure.

FIG. 4B conceptually shows an example of an application of a design for an example resistor form applicable in accordance with the present disclosure, wherein a snail structure resistor design is applied on a PCB of a BMS.

FIG. 5 is a view showing the configuration of a resistor design installed on a PCB of a BMS, wherein a conventional resistor element and an example of a resistor design applied to one side, both sides, and multilayer surfaces of a PCB in accordance with the present disclosure are shown for comparison.

FIG. 6 is a circuit diagram simply showing an example of the configuration of a circuit applicable to a system for performing battery cell balancing using a resistor design according to the present disclosure.

FIG. 7 is a view showing a comparison between heat generation experimental results under the same conditions when a conventional resistor element is applied to perform cell balancing and when a layered resistor design (straight resistor) according to the present disclosure is applied to perform cell balancing.

### BEST MODE FOR DISCLOSURE

Hereinafter, a battery management system for energy control according to a preferred embodiment will be described in detail with reference to the accompanying drawings.

For reference, in the following drawings, each component is omitted or schematically shown for convenience and clarity, and the dimensions of each component do not reflect actual dimensions and specifications. In addition, throughout the specification, the same terminology refers to the same component, and the same configuration may be described in the accompanying drawings, and specific drawing symbols and the like may be omitted.

The present disclosure may provide a system for managing a battery based on control or management of heat or temperature, typically through energy control, as an example of a battery management system.

According to a preferred embodiment of the present disclosure, the present disclosure relates to a method for managing battery cells to operate in a stable range by stably controlling energy to enable optimized charging and discharging of the battery cells by stably managing heat or temperature in response to physical and chemical changes, such as the capacity and temperature, of each cell caused by internal or external factors during the charging and discharging of the battery cells.

According to a preferred embodiment of the present disclosure, the battery management system is applicable to an ESS including a plurality of battery cells, and may be applied to batteries including one or more of lithium-ion battery cells, vanadium batteries, redox flow batteries (RFBs), and lead-acid batteries. More preferably, the battery management system is efficiently applied to vanadium-based batteries.

According to a preferred embodiment of the present disclosure, a preferred method of thermal management through energy control of the battery management system (BMS) provides a fast and efficient way to control the balancing of battery cells by properly managing the heat generated by the resistors.

According to a preferred embodiment of the present disclosure, the battery management system (BMS) of the present disclosure is essentially a control system electrically connected to a battery pack including a plurality of battery cells. The battery management system (BMS) provides battery protection, including monitoring the batteries, estimates the operating state of the batteries, continuously optimizes battery performance, and transmits the operating state to an external apparatus.

A battery system according to a preferred embodiment of the present disclosure includes balancing multiple battery cells that may be coupled to a battery pack and electrically connected in series and/or parallel in the battery pack such that the battery cells in the battery pack reach a similar or identical state of charge (SoC).

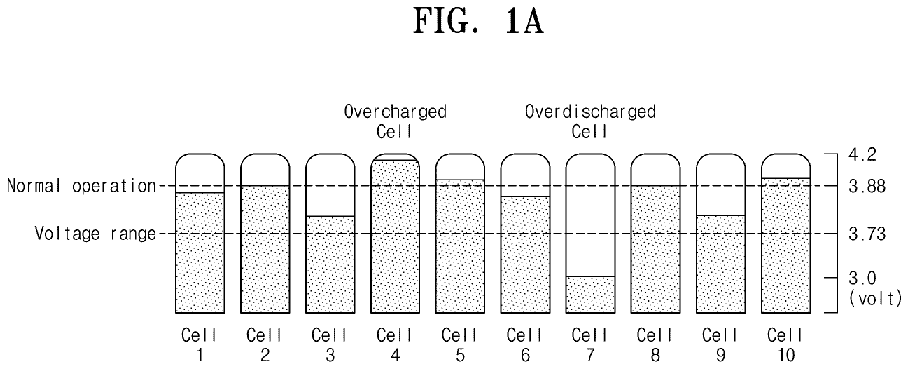

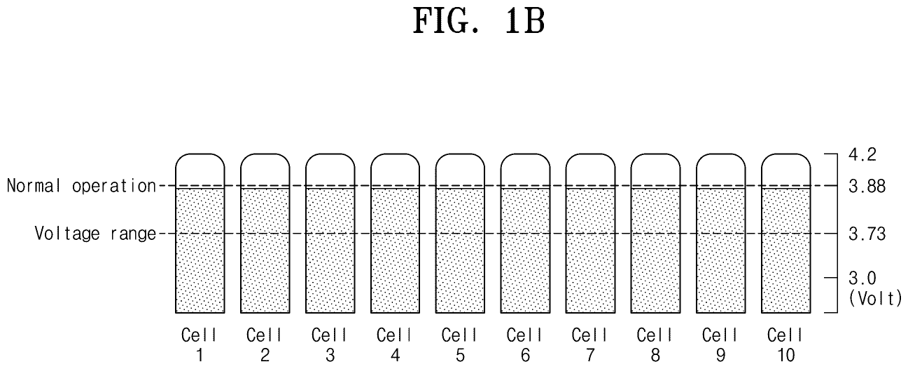

FIGS. 1A and 1B illustratively show the state of charge of cells before and after balancing, respectively.

In general, the absence of a BMS in a battery module may accelerate the damage of degraded battery cells during various processes. For example, during charging, the charge limit may be reached prematurely due to the decreased capacity of the degraded battery cells. The entire battery pack may continue to be charged even though the degraded battery cells have reached their charge limit. This overcharging may overcharge the already degraded battery cells, exacerbating the damage and accelerating failure of the battery pack. Similarly, during discharging, the discharge limit may be reached prematurely due to the decreased capacity of the degraded battery cells. The entire battery pack may continue to discharge even though the degraded battery cells have reached their discharge limit. This overdischarging may further damage the already degraded cells. Thus, a BMS is necessary to balance the battery cells.

Among the plurality of battery cells, some balancing schemes in which energy is removed from the most charged cell and lost as heat may be achieved by energy dissipation. On the other hand, some other balancing schemes may be non-dissipative in that energy is transferred to different cells, significantly reducing the energy lost as heat. Balancing by energy dissipation is referred to as passive balancing, whereas non-dissipative balancing is referred to as active balancing.

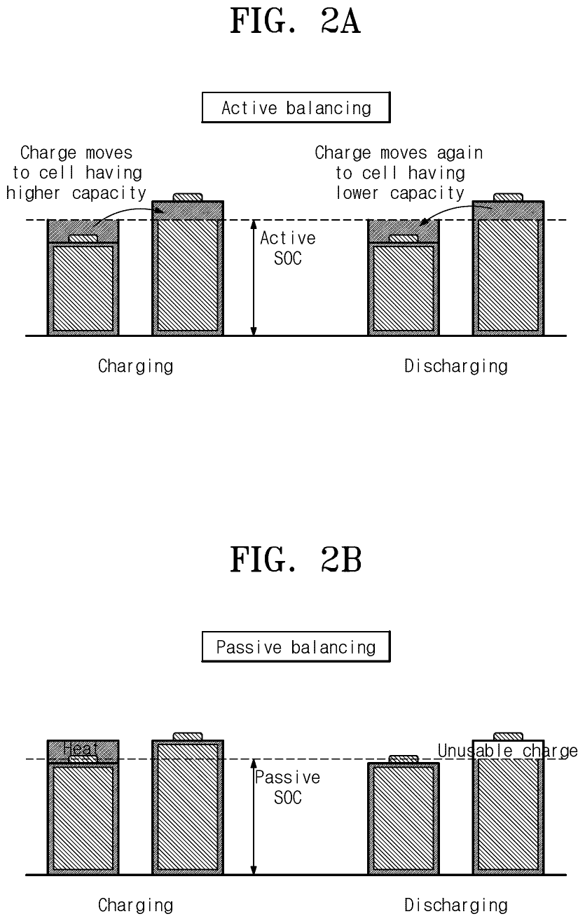

FIGS. 2A and 2B schematically show exemplary methods of active and passive balancing for battery cells, respectively.

In general, battery cells in a battery stack are monitored through passive and active balancing to maintain the same or similar state of charge (SoC) between the battery cells. This may extend battery life and prevent damage to the battery cells that may be caused by overcharging and/or overdischarging, as described above. Of these, passive balancing produces battery cells with similar or substantially the same state of charge by dissipating excess charge through a bleeder resistor. However, system operating time is not increased. On the other hand, active balancing is more complex balancing that redistributes charge in charge and discharge cycles, increasing the total amount of charge available in the battery pack, which increases system operating time, reduces charging time compared to passive balancing, and reduces heat generated during balancing.

Among the above energy balancing methods, passive balancing has a number of obvious disadvantages. For example, wasting energy may be bad for the environment. However, passive balancing has the advantage of being simple and low-cost. On the other hand, active balancing has obvious advantages because no energy is wasted, but active balancing may have disadvantages. For example, active balancing uses more electrical components, which may be disadvantageous due to higher cost, lower reliability, and/or greater bulk. In addition, standby current generated in active balancing may result in much greater power losses than in passive balancing.

The present disclosure proposes a preferred battery management system for performing passive balancing through energy control among the above-mentioned conventional energy balancing methods. In particular, such a passive balancing method is more suitable for application to vanadium-based batteries, which are charged and discharged at a low voltage.

Some battery cells lose capacity due to relatively slow chemical reaction that controls charging and discharging at low temperatures. For example, charging lithium-ion battery cells below 0° C. (32° F.) may be problematic because lithium precipitation from a negative electrode may occur during charging at temperatures below freezing. This is permanent damage, and not only results in reduced capacity, but also makes the cells more susceptible to failure if exposed to vibration or other stressful conditions. In addition, lithium-ion battery cells may experience performance loss when operated at a temperature much higher than room temperature (e.g., about 30° C. or higher). If the lithium-ion battery cells are continuously charged and recharged at the above temperature or higher, the performance loss may increase dramatically (e.g., up to 50%). In particular, continuous exposure to excessive heat during rapid charge and discharge cycles may lead to premature aging and degradation of battery life.

However, in the case of vanadium-based batteries, the batteries and BMS may be operated in a stable state under different conditions and environments.

According to a preferred embodiment of the present disclosure, the energy of the battery cells may be controlled to a stable state using a resistor designed for a specific condition as a way to ensure stable operation.

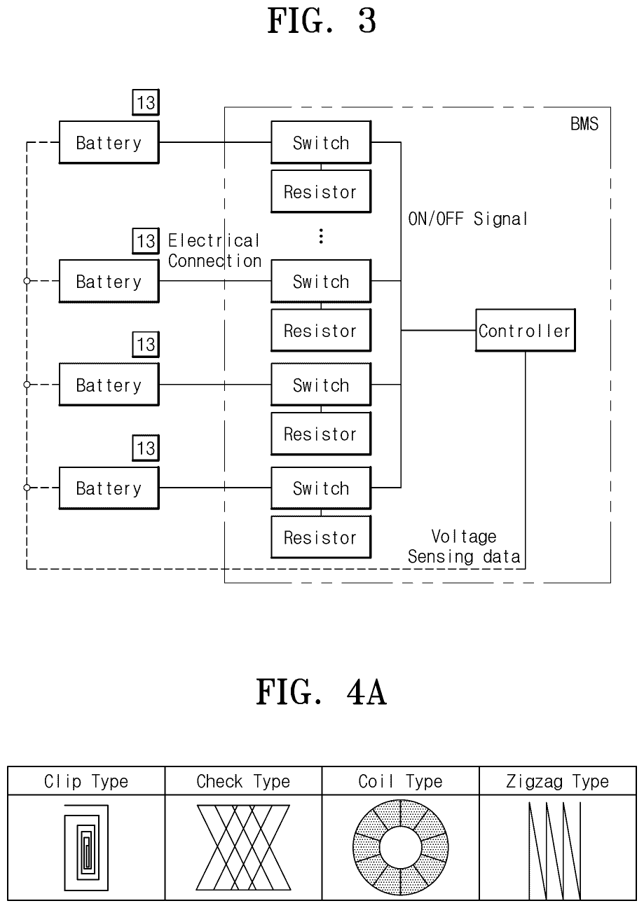

FIG. 3 schematically shows an exemplary battery system including a plurality of battery cells electrically connected to a battery management system (BMS), the system being designed by applying a resistor as a current management means according to the system configuration of the present disclosure.

According to a preferred embodiment of the present disclosure, the battery management system proposed by the present disclosure proposes a novel resistor design, for example, as a current control means to control energy in a stable state, thereby proposing various temperature and thermal management methods.

According to a preferred embodiment of the present disclosure, the illustrated BMS is preferably applied to passive balancing, and a plurality of battery cells may be electrically connected to each other in series and/or parallel.

According to a preferred embodiment of the present disclosure, a passive BMS is preferably applied to a resistive energy dissipation system when the current flowing in the battery stack is large as the result of the battery cells being connected in parallel.

According to a preferred embodiment of the present disclosure, the battery system further includes a plurality of switches, each connected to one of the battery cells. The battery system further includes one or more resistors electrically connected to the switches and configured to dissipate power from the battery cells upon activation of the one or more switches. The battery system further includes a controller configured to sense the state of charge (SoC) of the battery cells and to selectively activate the one or more switches based on the state of charge. For example, the controller may activate respective switches connected to one or more battery cells when the controller detects that the state of charge of the one or more battery cells is equal to or greater than a threshold after charging for a period of time, for example by measuring the voltage of the one or more battery cells. Alternatively, the excess charge may be selectively dissipated using respective resistors connected to the one or more battery cells. The controller may dissipate the excess charge from the one or more battery cells until the one or more battery cells have similar or substantially the same state of charge, as shown in FIG. 1.

FIG. 3 shows an exemplary battery management system (BMS) implemented on a circuit board (PCB) (busbars are not shown). Here, the switches and the controller are integrated into the circuit board (PCB). The PCB includes a terminal configured to electrically connect the plurality of battery cells to each other. By designing resistors on the PCB, the present disclosure enables passive balancing to be applied to stabilize the state of charge (SoC) of the plurality of battery cells to be in the same or similar state.

As a preferred embodiment of the present disclosure, the battery management system of the present disclosure is preferably applied as a system for balancing the voltage of each cell in the state in which the plurality of battery cells is connected to each other, i.e., in the state in which the batteries are connected to each other in the energy storage system (ESS), and may include, for example, a voltage measurement device, a switch configured to be opened and closed according to the voltage, and a current management means configured to consume or utilize current bypassed when the switch is closed, whereby stable management of the battery cells is achieved.

According to a preferred embodiment of the present disclosure, for example, the BMS applied to the ESS may include a voltage measurement device, a switch configured to be opened and closed according to the voltage, and an element including a load configured to consume current bypassed when the switch is closed, as an apparatus necessary to maintain the voltage of each of the cells at a constant level when the battery cells are electrically connected in series to increase the voltage. The element including the load preferably includes a resistance facility for bypass.

According to a preferred embodiment of the present disclosure, the bypass current may be increased to allow rapid cell balancing while maintaining temperature, heat, and energy stability. Here, performing cell balancing by increasing the bypass current is an important technical element in that it is possible to prevent the overall battery performance from deteriorating due to delayed cell balancing and the resulting disconnection of current, and to enable rapid passive cell balancing by increasing the bypass current to maintain a stable state of charge. In the present disclosure, rapid cell balancing may be easily achieved by increasing the bypass current.

According to a preferred embodiment of the present disclosure, the battery cell voltage is constant depending on the cell type, whereby the resistance of the load must be controlled low in order to increase the balancing current of the battery cell. However, low load resistance requires a large size of the load, which may increase the size and cost of the BMS board.

According to the present disclosure, in general, problems arise in the ESS due to differences in voltage or state of charge (SoC) of the battery stack. For example, if the internal resistance deviates from a certain range, the voltage deviation between cells occurs, and if one of the cells reaches the upper limit voltage, the battery may be blocked.

Therefore, it is desirable to solve the problem by reducing the voltage difference between the cells by applying passive balancing, which is simple in design, and dissipating energy by flowing current.

According to the present disclosure, for example, in order to dissipate energy by flowing high current, it is necessary to create a low resistance value condition of a resistor, but if a resistor element is applied to the BMS, an element having a low resistance value is usually small in size and has a small endurance capacity, which is not suitable for flowing high current.

In the present disclosure, it was realized that these problems can be solved by applying a simple wire-type resistor in the BMS, which is easy to handle and has a relatively large resistance component compared to a general resistor element. However, even in the case of such a wire-type resistor, it is difficult to cut and manage the wire-type resistor, and it is difficult to manage heat due to high current generated in the wire, which may melt a sheath and expose the wire or cause substrate short circuit.

Therefore, according to a preferred embodiment of the present disclosure, in order to solve the above problems, a new system is implemented in which a laminated type of resistor is designed and utilized as a current management means on the circuit board (PCB) in the BMS, which not only simplifies the process but also secures space by not applying an element, and reduces the thickness by not using a high-capacity resistor element with a large thickness.

According to a preferred embodiment of the present disclosure, solving the above problems may provide a BMS that maintains energy and temperature stability while performing cell balancing by increasing the bypass current for stable management of battery cells.

According to a preferred embodiment of the present disclosure, for such a stable BMS configuration, a resistance facility for bypass may be included as a method of controlling the state of charge (SoC) of the battery cells, e.g., as a current management means for cell balancing. Energy control is possible and heat generation is induced to maintain temperature stability of the battery cells through the resistance means.

According to a preferred embodiment of the present disclosure, the present disclosure may constitute a BMS in which the resistor applied as a current management means is a laminated resistor, preferably a laminated wire-type resistor, instead of a general resistor. This form of resistor may reduce the cost of resistor components and may be integrated into the PCB substrate, thus reducing and minimizing the BMS volume by reducing height.

According to a preferred embodiment of the present disclosure, the resistance may be controlled by the thickness, length, and material of the wire for forming the resistor, and it is advantageous to densely pack the wires to reduce the size of the substrate, but densely packed wires may not allow heat dissipation and may cause damage to the resistor or the substrate due to excessive temperature rise. In this case, it is necessary to reduce the temperature of the resistor.

According to a preferred embodiment of the present disclosure, the resistance facility for bypass may include a resistance means having a permissible power value of 2 W or more. The resistance means may be formed, for example, on the surface of the PCB.

As such, the present disclosure may enable efficient ESS battery management by adjusting the deviation of voltage values between cells by passive balancing in which balancing is accomplished by supplying a high current to a resistor to consume energy to balance the battery cells.

According to a preferred embodiment of the present disclosure, the resistance facility for bypass may have a standard resistor area of 60 mm² or more when the standard resistor package number is 4000 or higher. If the standard resistor area is too small, energy control to ensure that desired cell balancing is maintained may be difficult.

According to a preferred embodiment of the present disclosure, the resistance facility for bypass may include a resistor having a resistance of less than 1.5Ω to 1μΩ, a width of 0.09 to 0.34 mm, and a length of 140 to 210 mm when the standard resistor package number is 4000 or higher, in a configuration wherein the width and length of the resistor increase in a mutually proportional ratio in proportion to a decrease in the resistance and wherein the proportional relationship is established in a regular or irregular ratio within the range. Reference is established to IPC-2221 and IPC-9592B for standard resistor. The standard resistor package number is expressed in inches, for example, if the standard resistor package number is 4012, this means that the resistor is 0.4 inch×0.12 inch in size. This may also be expressed in metric units, in which a standard resistor of 4012 (in) is equivalent to 10130 (mm). In the present disclosure, the standard resistor package numbers are presented with reference to standards such as JEDEC, EIAJ, and IEC60115-8, but there may be slight differences between standards, and the standard resistor package numbers of the present disclosure are not limited to any specific standard.

If the resistance is too low or too high, insufficient energy control or unnecessary power consumption may occur. If the width and length of the resistor deviate from the proportion range, insufficient resistance or overload may result in heat generation, make energy control impossible, etc. Such a configuration of the resistor leads to efficient resistance generation in a limited PCB area, allowing stable energy control.

According to a preferred embodiment of the present disclosure, the resistance facility for bypass may include a wire resistor having one or more of the following shapes: a snail structure, a spiral structure, a series or parallel type straight cluster structure, a curved cluster structure, or a mixed cluster structure.

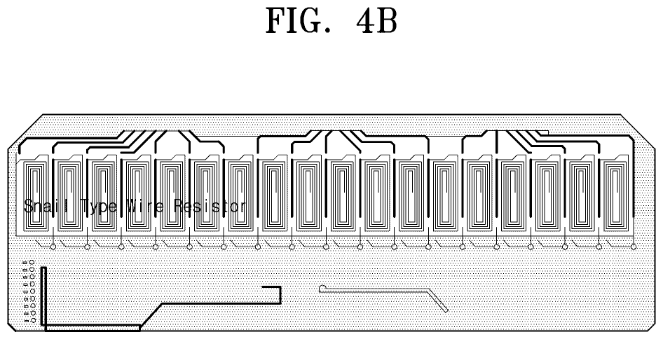

According to a preferred embodiment of the present disclosure, the resistance facility for bypass may be configured in various forms, as shown in FIG. 4. Various shapes of resistor wires may be configured as the resistance facility. For example, the wire resistor may be configured in a snail (or clip) structure, in a spiral structure, or in a straight cluster structure, or the like.

FIG. 4A conceptually shows an example configuration of an exemplary form of resistor applicable on the PCB of the BMS in accordance with the present disclosure. In the figure, the clip type is utilized by applying thermal management, the check type (parallel type) is easy to manage thermally but requires a relatively large area, and the coil type has a structure suitable for wireless charging.

FIG. 4B conceptually shows an example of an application of resistor design, wherein a snail structure resistor design is applied on the PCB of the BMS.

According to a preferred embodiment of the present disclosure, the application form of the resistor as described above is preferable in terms of efficiency to apply the resistor design in the form of a series when the substrate temperature specification is higher than the heating temperature of the resistor, and if the heating is large, the resistor design may be configured by increasing the width and length of the resistor wire to reduce the heating.

The resistor of the present disclosure is preferably made of copper. In a conventional general resistor, a ceramic such as cement is wrapped around a nichrome wire, and the nichrome wire is required to prevent oxidation and withstand high temperatures, and the ceramic has a problem that the temperature rises easily due to poor heat conduction and heat dissipation is difficult. Therefore, it is difficult to utilize the heat generated by the resistor. However, when the resistor made of copper is used as in the present disclosure, even if the same heat is generated, the heat generation density per unit area is lower and the heat conduction is faster because the copper is laminated. Therefore, it is easy to utilize the generated heat and the heat may be dissipated quickly when the heat is not needed, making it easy to manage heat and temperature.

According to a preferred embodiment of the present disclosure, the resistance facility for bypass may include a short circuit means configured to cause short circuit when the current is equal to or greater than a set threshold current.

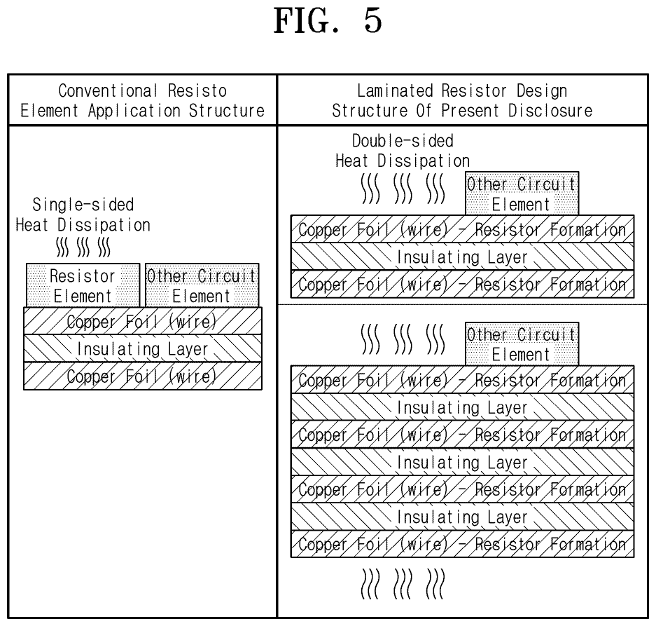

FIG. 5 is a view showing the configuration of a resistor design installed on the PCB of the BMS, wherein a conventional resistor element and an example of a resistor design applied to one side, both sides, and multilayer surfaces of the PCB in accordance with the present disclosure are shown for comparison.

According to a preferred embodiment of the present disclosure, the resistance facility for bypass may include a single-layer or multilayer arrangement on or under the PCB, and may be configured such that the currents in the resistors flow in opposite directions at positions corresponding to each other. This type of resistor configuration may be formed as a single layer or multiple layers on one or both surfaces of the PCB, as illustrated in FIG. 5.

According to a preferred embodiment of the present disclosure, a conventional high power device is typically mounted on the PCB, which requires the device to dissipate heat. Therefore, the device is bulky and requires a larger area for heat dissipation if a heat sink is added to the device. However, designing the resistor in a laminated form on the PCB, as exemplified in the present disclosure, is very space-saving.

According to a preferred embodiment of the present disclosure, the resistor may be applied to one surface, both surfaces, and multilayer surfaces of the PCB. As such, layering the resistors on and under the PCB is very advantageous in that the heat generated by the resistors can be dissipated to one side or both sides of the substrate. In addition, when a multilayer substrate is applied as the PCB, the design of resistors between the substrates may be utilized to further increase the area of the resistors for heat suppression. Furthermore, it is possible to install an additional heat dissipation structure in the space where the high power device is missing. The present disclosure encompasses all forms of such layered resistor designs on substrates.

According to a preferred embodiment of the present disclosure, in connection with the case of designing the resistors in a laminated form on the PCB as described above, the present disclosure may be applied to use a copper wire as a layered resistor wire on the PCB. That is, according to an embodiment of the present disclosure, for example, an insulating layer may be formed with glass fiber, epoxy, and the like between copper foils, each of which is a copper resistor, formed on the PCB.

According to a preferred embodiment of the present disclosure, the resistance facility for bypass according to the present disclosure may include a single-layer or multilayer arrangement on or under the PCB, and may be configured such that the currents in the resistors on both surfaces of the PCB substrate flow in opposite directions at positions corresponding to each other. If a pattern of straight lines continues in the same direction, a magnetic field is formed in the direction in which the current flows. Therefore, in the resistor design of the present disclosure, preferably in the design of a double-sided PCB and multilayer PCB, the directions of the pattern are crossed with each other so that the current flows in opposite directions at corresponding positions to suppress the formation of a magnetic field. However, conversely, if it is necessary to transfer power through a magnetic field, such as for wireless charging, all layers may have the same connection direction. The present disclosure includes all of these methods and a battery management apparatus applicable to these methods.

Thus, an embodiment of the present disclosure provides a battery management apparatus for energy control configured to balance the voltage of each cell in the state in which a plurality of battery cells is connected to each other, the apparatus including a voltage measurement device, a switch configured to be opened and closed according to the voltage, a resistance facility laminated in a single layer or multiple layers on a circuit board (PCB) of the battery management apparatus (BMS) as a current management means configured to consume or utilize current bypassed when the switch is closed, and a cell balancing means configured to stabilize the state of charge in a passive manner using the resistance facility, whereby temperature management is achieved.

According to a preferred embodiment of the present disclosure, in the battery management apparatus as described above, the resistance facility may be laminated on one side, both sides, or multiple layers of the PCB using copper wires with an insulating layer therebetween.

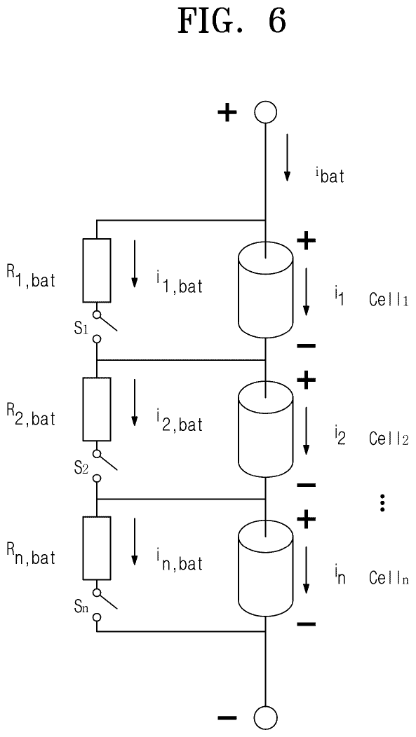

According to a preferred embodiment of the present disclosure, in order to realize such a system, a circuit configuration shown in FIG. 6 may be provided.

FIG. 6 is a circuit diagram simply showing an example of the configuration of a circuit applicable to a system for performing battery cell balancing through energy control using a resistor design according to the present disclosure.

According to a preferred embodiment of the present disclosure, when battery cells are severely out of balance, it may be necessary to partially or fully increase balancing current to bypass a large amount of current. In this process, the large current flow allows for rapid cell balancing, but may generate heat, which may require appropriate measures for heat and temperature management. Typically, a balancing current is considered large if the balancing current is equal to or greater than 0.5% of the main current, and a large balancing current enables relatively rapid cell balancing.

According to the present disclosure, heat generated when energy control is performed by the resistance means may be stabilized through temperature control. For example, the heat may be dissipated, and the heat thus dissipated may be utilized as another means of thermal management of the battery cells by heat dissipation.

The present disclosure preferably utilizes the resistance facility to perform passive balancing for energy control of the battery cells as described above, and thus is simple in construction and low in cost. However, since power losses occur and power is dissipated as heat, heat management is required.

According to a preferred embodiment of the present disclosure, a heat dissipation means may be provided for the case in which heat is generated in the battery cells by using the resistance facility or by other means.

According to a preferred embodiment of the present disclosure, as part of the heat dissipation means or for stable temperature management, a structure for sharing heat between the battery cells may be employed. To this end, for example, individual heat sinks may be attached to the wire-type resistors to dissipate heat, or a fin structure may be applied for heat dissipation. Here, a method of sharing heat with neighboring resistors that are not balanced by a common heat sink and thus have lower temperatures is preferably applied to reduce the average temperature.

According to a preferred embodiment of the present disclosure, a method of dissipating heat or preventing the concentration of heat using a driving unit such as a motor by using a balancing current may be applied as a means for heat management. In this case, some or all of the resistors may be replaced by a motor load.

According to a preferred embodiment of the present disclosure, heat from the BMS balancing current may be shared in the BMS to shave temperature peaks in certain channels (resistors), or heat may be drawn out of the BMS or to a specific position in the direction of the motor.

In addition, according to a preferred embodiment of the present disclosure, the thermal energy dissipated by the resistors or for other reasons may be collected and utilized as an additional source of energy.

According to a preferred embodiment of the present disclosure, a temperature sensor may be provided at or around each of the battery cells for thermal management. A temperature sensitive material may be used as a component of the temperature sensor.

According to an embodiment of the present disclosure, as part of a QC method to determine if the BMS is functioning properly, a temperature sensitive material that changes color with temperature, for example, in the form of paint or a sheet, may be implemented to detect the heat generated by the operation of the BMS. In this case, the color change of the temperature sensitive material may be used to distinguish between reactive and non-reactive portions of the material. For example, both a permanently changing material and a material having color restored upon restoration of temperature may be used as the temperature sensitive material.

When applied to manage the heat generated during the battery cell balancing process of the BMS in the above manner, highly efficient thermal management becomes possible.

According to an embodiment of the present disclosure, the management system of the present disclosure may include a short circuit means configured to cause short circuit if the current is equal to or higher than a set threshold current by adding a section of thinning at a certain position of the wire pattern if the balancing current is recognized to be high. In this case, the system may be more reliably managed against overcurrent during the balancing process using the short circuit means configured to act as if it were a fuse. In addition, according to a preferred embodiment of the present disclosure, when a fuse function is performed by the short circuit means and disconnection occurs, a function of recognizing the same and transmitting an abnormality signal to a main control system may be further included.

Meanwhile, in another embodiment, the present disclosure provides a battery management method including: measuring the voltage of battery cells connected to each other, the voltage of the battery cells being increased to perform voltage uniformity matching between the battery cells when measuring the voltage;
performing selective switching such that bypass current selectively flows to one or more loads connected to each of the battery cells;
checking each of the one or more loads that consume or utilize the bypass current after each switch is actuated for a corresponding one of the loads; and
performing relatively rapid cell balancing of the battery cells to achieve stable thermal management compared to a conventional method that does not utilize the bypass current.

According to a preferred embodiment of the present disclosure, the relatively rapid cell balancing may be performed taking into account at least one of the following conditions after performing at least one of the measurement step, the switching step, and the checking step.

For example, the bypass current has a relatively large size to increase the balancing current when the amount of imbalance to a corresponding battery cell is severe, the relatively large current used for cell balancing generates a relatively large amount of heat, a correspondingly low load resistance is required to increase the current for cell balancing, and one or more loads have a relatively large size to achieve the relatively low resistance, in which case the cost is increased and the size of the printed circuit board (PCB) of the BMS is increased.

According to a preferred embodiment of the present disclosure, at least one of the loads may include one or more conductive lines having a specific layout integrated into the PCB instead of using a conventional resistor part. The above-mentioned resistor design may be applied with the conductive lines.

According to a preferred embodiment of the present disclosure, heat dissipation for the conductive lines may be achieved by employing at least one of specific distances between the conductive lines, a heat sink, and a heat dissipating fin element. In such a case, the heat dissipation means or the temperature sensitive sensor may be applied. For example, temperature sensitive paint or a color-changing element may be applied or disposed at or near the PCB to visually determine whether heat dissipation is effective.

In a preferred embodiment of the present disclosure, at least one of the loads is a motor load related to a motor provided at or near the PCB, whereby the motor may be operated to achieve temperature peak shaving in the BMS or to direct heat away from the PCB.

The present disclosure, as described above, is a system that is very suitable for minimizing the energy variation in a vanadium-based battery cell, such as a vanadium ion battery (VIB) due to the internal resistance of the cell and using a relatively high current to charge and discharge the battery.

Accordingly, the present disclosure provides a battery management system for energy control configured to perform a method of balancing the voltage of each cell in the state in which a plurality of vanadium-based battery cells is connected to each other, the system including a voltage measurement device, a switch configured to be turned on or off in accordance with the voltage, a resistance means applied to the PCB in a laminated state as a current management means configured to consume or utilize current bypassed in the state in which the switch is on, and a means configured to control energy using the resistance means to perform cell balancing and to manage the temperature generated during an energy control process, whereby a battery charging and discharging state is stabilized.

According to a preferred embodiment of the present disclosure, performing cell balancing of the vanadium-based battery cells as described above may be, for example, actively or passively balancing the state of charge (SoC) value and performing temperature management of the vanadium-based battery cells by increasing the temperature of the vanadium-based batteries by 5° C. or more. This may have a desirable effect on improving the performance of the vanadium-based batteries by dissipating heat generated during the passive balancing process through energy control using the resistance facility and managing the dissipated heat to improve the performance of the vanadium-based batteries.

According to a preferred embodiment of the present disclosure, the temperature management may be controlled so as to maintain an optimal operating efficiency temperature range of 15 to 40° C. and not to exceed 50° C. in any case.

According to a preferred embodiment of the present disclosure, the temperature of the battery may be controlled so as to maintain an optimal operating efficiency temperature range of 15 to 40° C., and the temperature of the PCB may be controlled so as not to exceed the temperature deviating from the specifications of the PCB. For example, it is necessary to control low glass transition temperature (T_{g}) to 130° C. to 140° C., medium T_{g} to 150° C. to 160° C., and high T_{g} to 170° C. to 180° C., which are temperatures that the PCB can withstand.

As described above, the battery management system for energy control according to the present disclosure is capable of performing passive balancing in a simple and efficient manner for energy control in a stable state by applying the resistance facility to the PCB in a laminated form in performing balancing for the battery cells of the ESS.

Therefore, the battery management system according to the present disclosure has the advantage of simplifying the process by eliminating the need for mounting separate components such as resistor elements in a laminated form in which the resistors are printed or inserted in the PCB substrate, and it is advantageous for heat generation and temperature control because heat can be dissipated on both surfaces through a double-sided resistor design due to the layered resistors.

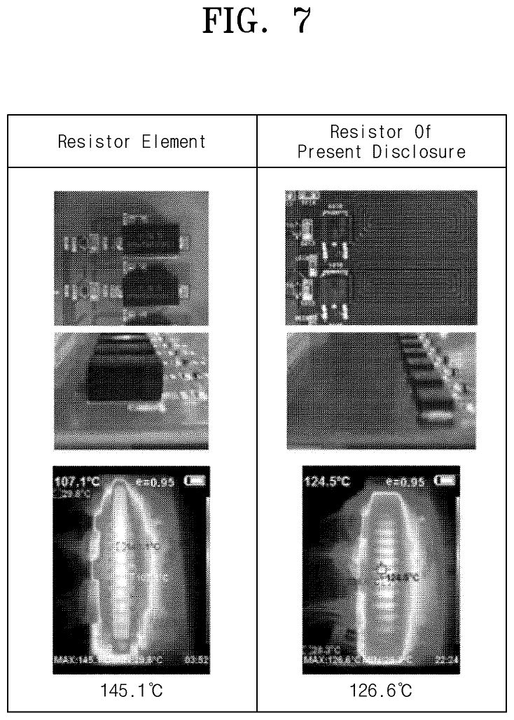

In order to check the heat generation state in practice, the present disclosure conducted a comparison experiment between the case of applying a conventional resistor element and the case of applying a layered resistor design (straight resistor) according to the present disclosure under the same conditions. The results of the experiment are shown in FIG. 7 as thermal image results. As a result of the experiments, a reduction in heat generation of about 20% could be expected. From the result of the experiments, it is confirmed that the energy control type resistor design of the present disclosure has a significantly superior effect in terms of heat suppression alone.

In addition, the present disclosure may be similar in width and length to a conventional resistor, but the height is dramatically reduced, enabling a significantly more advantageous space to be secured, and since the secured space can be utilized, another necessary facility such as a heat sink for temperature control may be installed in the secured space.

### Experimental Example

The present experiment is the result of an experiment carried out to confirm the correlation between the resistor area in the resistor design and the width and length of the resistor wire in the case of controlling energy to a stable state of the battery cells when cell balancing is performed by constituting a laminated resistor design as a current management means for balancing the battery cells. The following standard resistor package number is expressed in inches, for example, if the standard resistor package number is 4012, this means that the resistor is 0.4 inch×0.12 inch in size. This may also be expressed in metric units, in which a standard resistor of 4012 (in) is equivalent to 10130 (mm). In the present disclosure, the standard resistor package numbers are presented with reference to standards such as JEDEC, EIAJ, and IEC60115-8, but there may be slight differences between standards, and the standard resistor package numbers of the present disclosure are not limited to any specific standard. In this experiment, vanadium ion battery cells were used as the battery cells, and the experimental specifications, resistance calculation and resistance comparison experimental results are shown in the following table.

TABLE 1

| Standard | | | | | | Minimum |
|---|---|---|---|---|---|---|
| resistor | | | | Minimum resistance | Normal | resistor |
| package | Experimental | Normally | Maximum | width according to | standard | area of |
| number | resistance | allowable | balancing | maximum current | resistor | disclosure |
| (in inches) | (Ω) | power (W) | current (A) | (μm) | area (mm²) | (mm²) |
| 0201 | 45.0 | 0.05 | 0.033 | 0.581 | 0.18 | 9.31 |
| 0402 | 22.5 | 0.1 | 0.067 | 1.511 | 0.50 | 12.15 |
| 0603 | 22.5 | 0.1 | 0.067 | 1.511 | 1.28 | 12.15 |
| 0805 | 18.0 | 0.125 | 0.083 | 2.056 | 2.50 | 13.25 |
| 1206 | 9.0 | 0.25 | 0.167 | 5.349 | 5.12 | 17.45 |
| 1210 | 4.5 | 0.5 | 0.333 | 13.916 | 8.00 | 23.44 |
| 1218 | 2.3 | 1 | 0.667 | 36.020 | 14.72 | 32.96 |
| 2010 | 4.5 | 0.5 | 0.333 | 13.916 | 12.50 | 23.44 |
| 2512 | 2.3 | 1 | 0.667 | 36.020 | 20.48 | 32.96 |
| 3014 | 2.3 | 1 | 0.667 | 36.020 | 27.36 | 32.96 |
| 4014 | 1.5 | 1.5 | 1.000 | 63.331 | 36.00 | 41.96 |
| 4026 | 1.1 | 2 | 1.333 | 94.177 | 63.00 | 51.27 |
| 5012 | 1.1 | 2 | 1.333 | 94.177 | 62.50 | 51.27 |
| 5025 | 1.1 | 2 | 1.333 | 94.177 | 78.75 | 51.27 |
| 6432 | 0.8 | 3 | 2.000 | 164.752 | 128.00 | 71.70 |
| 6717 | 0.8 | 3 | 2.000 | 164.752 | 119.00 | 71.70 |
| 6720 | 0.8 | 3 | 2.000 | 164.752 | 153.00 | 71.70 |
| 8518 | 0.5 | 5 | 3.333 | 333.295 | 386.64 | 121.57 |
| 8532 | 0.5 | 5 | 3.333 | 333.295 | 686.88 | 121.57 |
| 8540 | 0.5 | 5 | 3.333 | 333.295 | 859.68 | 121.57 |
| 10202 | 0.3 | 7 | 4.667 | 530.133 | 1326.00 | 183.95 |

The above experimental results show the critical effect on the numerical limit range of the resistor design of the present disclosure.

While preferred embodiments of the present disclosure have been described above with reference to the accompanying drawings, it should be understood that the embodiments described in this specification and constructions shown in the drawings are merely the most preferred embodiments and do not speak for the entirety of the technical idea of the present disclosure, and therefore various replaceable equivalents and modifications may be possible at the time of filing the present application. Therefore, the description and examples set forth above are to be understood as exemplary as an embodiment and not limiting in all respects, and the scope of the present disclosure is indicated by the following claims rather than by the detailed description, and all modifications or variations derived from the meaning and scope of the claims and the equivalent concepts thereof are to be construed as being within the scope of the present disclosure.

1. A battery management system for energy control configured to balance a voltage of each cell in a state in which a plurality of battery cells is connected to each other, the battery management system comprising:
a voltage measurement device;
a switch configured to be opened and closed according to the voltage; and
a current management means configured to consume or utilize a bypass current bypassing one or more of the battery cells when the switch is closed, wherein the bypass current is consumed or utilized for temperature management of the battery cells.

2. The battery management system of claim 1, wherein the bypass current is increased to maintain temperature stability while performing rapid cell balancing.

3. The battery management system of claim 1, further comprising a resistance facility for bypass configured to perform the temperature management of the battery cells.

4. The battery management system of claim 3, wherein the resistance facility for bypass comprises a resistance means having an allowable power value of at least 1 W.

5. The battery management system of claim 3, wherein the resistance facility for bypass has a standard resistor area of 60 mm² or more when a standard resistor package number is 4000 or higher.

6. The battery management system of claim 3, wherein the resistance facility for bypass is configured such that a resistor has a resistance value of less than 1.5Ω to 1μΩ.

7. The battery management system of claim 6, wherein the resistance facility for bypass comprises a resistor configured such that, under conditions that the resistor has a width of 0.09 to 0.34 mm and a length of 140 to 210 mm, the width and the length of the resistor increase in a mutually proportional ratio in proportion to a decrease in the resistance value and a proportional relationship is established in a regular or irregular ratio within the range.

8. The battery management system of claim 3, wherein the resistance facility for bypass comprises a wire-type resistor having one or more of a snail structure, a spiral structure, a series or parallel type straight cluster structure, a curved cluster structure, or a mixed cluster structure.

9. The battery management system of claim 3, wherein the resistance facility for bypass comprises a short circuit means configured to cause short circuit when the current is equal to or greater than a set threshold current.

10. The battery management system of claim 3, wherein the resistance facility for bypass has a single-layer or multilayer arrangement on or under a printed circuit board (PCB) and is configured such that currents in resistors flow in opposite directions at positions corresponding to each other.

11. The battery management system of claim 1, further comprising a heat sink or a fin structure attached one or more of the battery cells for heat dissipation.

12. The battery management system of claim 1, comprising a structure for sharing heat between the battery cells.

13. (canceled)

14. The battery management system of claim 1, further comprising a means configured to dissipate heat by driving a motor using a balancing current.

15. (canceled)

16. (canceled)

17. A battery management method comprising:
measuring a voltage of battery cells connected to each other, the voltage of the battery cells being increased to perform voltage uniformity matching between the battery cells when measuring the voltage;
performing selective switching such that a bypass current selectively flows to one or more loads connected to each of the battery cells;
checking each of the one or more loads that consume or utilize the bypass current after each switch is actuated for a corresponding one of the one or more loads; and
performing relatively rapid cell balancing of the battery cells to achieve stable thermal management compared to a conventional method that does not utilize the bypass current.

18. The battery management method of claim 17, wherein
the relatively rapid cell balancing is performed taking into account at least one of following conditions after performing at least one of the measuring step, the switching step, and the checking step:
the bypass current has a relatively large size to increase a balancing current when an amount of imbalance to a corresponding battery cell is severe;
the relatively large current used for cell balancing generates a relatively large amount of heat;
a correspondingly low load resistance is required to increase the current for cell balancing; and
the one or more loads have a relatively large size to achieve a relatively low resistance, in which case a cost is increased and a size of a printed circuit board (PCB) of a battery management system (BMS) is increased.

19. The battery management method of claim 17, wherein at least one of the one or more loads comprises one or more conductive lines having a specific layout integrated into a PCB instead of using a conventional resistor part.

20. The battery management method of claim 19, wherein heat dissipation for the one or more conductive lines is achieved by employing at least one of specific distances between the one or more conductive lines, a heat sink, and a heat dissipating fin element.

21. The battery management method of claim 17, wherein at least one of the one or more loads is a motor load related to a motor provided at or near a printed circuit board (PCB), whereby the motor is operated to achieve temperature peak shaving in a battery management system (BMS) or to direct heat away from the PCB.

22. The battery management method of claim 17, wherein a temperature sensitive paint or a color-changing element is applied or disposed at or near a printed circuit board (PCB) to visually determine whether heat dissipation is effective.

23-29. (canceled)
